(19) United States
(12) Patent Application Publication
(10) Pub. No.: US 2021/0319406 A1
(43) Pub. Date: Oct. 14, 2021

(54) Computer Implemented Online System For Ready For Production

(71) Applicant: Aleksandr Agapitov, North Hollywood, CA (US)

(72) Inventor: Aleksandr Agapitov, North Hollywood, CA (US)

(21) Appl. No.: 17/219,819

(22) Filed: Mar. 31, 2021

Related U.S. Application Data
(60) Provisional application No. 63/002,987, filed on Mar. 31, 2020.

(51) Int. Cl. G06Q 10/10; G06F 40/174

(52) U.S. Cl. CPC G06Q 10/1053; G06F 40/174; G06Q 10/107

(57) ABSTRACT

A computer-implemented system and method for a computer implemented online system for ready for production requests for companies to find and connect to qualified professionals and hiring them. The system comprises a) at least one computer hardware processor; and b) at least one non-transitory computer-readable storage medium storing professional information and processor-executable instructions that, when executed create a job posting. Enter the job posting into the non-transient storage including tags. Post the job. Pay for the job posting to be published. Automatically publishing the job posting. Automatically search the non-transitory computer-readable storage medium for talent to fill the job posting based on the tags entered. Automatically receiving talent applications in response to the job posting. Selecting talent from the received applications. Notifying the selected talent and sending the selected talent an application. Receiving the completed application from the selected talent. Finally, hiring the selected talent.

### CROSS-REFERENCE TO RELATED APPLICATIONS

This application claims the benefit under 35 U.S.C. § 119(e) of U.S. Provisional Patent Application Ser. No. 63/002,987, filed on Mar. 31, 2020, the contents of which are incorporated herein by reference in their entirety.

### FIELD OF THE INVENTION

The present invention is in the technical field of online recruitment and more particularly to a computer implemented online system for ready for production requests for companies to find and connect to qualified professionals and hiring them.

### BACKGROUND

Currently, the global industry is exploding in the next two years. In order to compete, companies need qualified professionals. However, the currently available method of hiring is limited to job boards where candidates place their resumes and other information and the companies are then left to sift through them all to attempt to locate qualified candidates. As can be appreciated, this is inefficient in a rapidly changing and demanding market. The hiring process is a hit or miss proposition at best and takes too long in order to find qualified candidates.

Companies will have a variety of positions that are needed to be filled and the current methods of finding quality, qualified job candidates is too time consuming and unreliable. The qualifications needed to be filled can vary greatly from project to project. For example, a middle, or high-quality professionals, artists, animators, 3D modelers, VFX people with various levels of experience. Currently, it is too difficult for companies that are competing with each other to find qualified candidates on the open market. This leads to corporate raiding of talent from each other and hiring of non-qualified personnel.

The candidate side of the hiring equation is equally difficult. Looking for a new job is painful as there are too many requests that are not for the candidate specifically. Candidates don't want to waste time tailoring their resumes by recreating existing portfolios to meet the hiring companies expectations. Additionally, current candidates are mostly on social media and not looking to the job hiring websites. This leaves a disconnect between the traditional hiring model currently available to companies and the candidates.

Additionally, there is no convenient system of communication with professionals that would allow companies to effectively inquire about a large number of topics from the professional. There is no catalog of ready-to-work professionals currently available.

Therefore, there is a need for a computer implemented online system for ready for production requests (RFP) for companies to find and connect to qualified professionals and hiring them that overcomes the limitations of the prior art.

### BRIEF DESCRIPTION OF THE DRAWINGS

These and other features, aspects and advantages of the present invention will become better understood with regard to the following description, appended claims, and accompanying figures where:

FIG. 1 is a overview diagram of a computer implemented online system for ready for production requests for companies to find and connect to qualified professionals and hiring them, according to one embodiment of the present invention; and

FIG. 2 is a flowchart diagram of a computer-implemented method for generating ready for production requests for companies to find and connect to qualified professionals and hiring them.

### SUMMARY

A computer-implemented method for generating ready for production requests for companies to find and connect to qualified professionals and hiring them. The computer-implemented method comprises the steps of creating a job posting; entering the job posting into a non-transient storage including tags; posting the job; paying for the job posting to be published; automatically publishing the job posting; automatically searching for talent to fill the job posting based on the tags entered; automatically receiving talent applications in response to the job posting; selecting talent from the received applications; notifying the selected talent and sending the selected talent an application; receiving the completed application from the selected talent; and hiring the selected talent.

The step of creating the job comprises a user entering the name of position, text description, location, and specifies requirements in knowing particular skills, styles and tools. When the job posting is created, information about each automatically selected candidate and questionnaires associated with each automatically selected candidate is sent to the user. The questionnaire is a default form and comprises set of questions that are customizable each job posting.

The job postings are paid individually, by subscription or both individually and subscription; wherein posting jobs on the board and receiving applications is paid individually, and searching the non-transient storage database and connecting with professionals directly is paid by subscription. Each individual job posting displays a payment interface to a user. Completion of the payment automatically publishes the job posting, and a link to a job board with the job posting is automatically provided to the user. Additionally, the published job posting is made visible for professionals on the job board and is open for public viewing. Subscription users can manually select professionals and gain access to every professional's profile from the non-transient storage database using one or more than one pre-set filters. The pre-set filter comprise: skills, experience, styles, tools, and location. The list of professionals displayed by the one or more than one pre-set filters, can be added to a favorites list for later review.

The step of selecting talent from the received applications displays a profile of detailed information about the professional, including the name, location, current position, skills with experience level, styles, tools, education, and work samples. The profile can be add it to a favorites list for later inspection or direct communication with the professional. Selecting the professional from the displayed list automatically sends an email to the selected professional, wherein the email comprises links from the job board or email notification to a questionnaire form associated with the job posting. The professional is required to answer all questions from the questionnaire to complete an application. Completion of the application automatically sends an email notification to the user and adds the professional to a job posting list related to the user.

The listed candidates from the automatic or manual selection for the job posting displays a detailed view of all applications, including a list of received/pending applications, professionals names, positions, locations, links to profiles and questionnaire responses.

There is also provided a computer-implemented system for ready for production requests for companies to find and connect to qualified professionals and hiring them. The system comprises at least one computer hardware processor; and at least one non-transitory computer-readable storage medium storing professional information and processor-executable instructions that, when executed by the at least one computer hardware processor, cause the at least one computer hardware processor to perform: creating a job posting; entering the job posting into a non-transient storage including tags; posting the job; paying for the job posting to be published; automatically publishing the job posting; automatically searching for talent to fill the job posting based on the tags entered; automatically receiving talent applications in response to the job posting; selecting talent from the received applications; notifying the selected talent and sending the selected talent an application; receiving the completed application from the selected talent; and hiring the selected talent.

### DETAILED DESCRIPTION OF THE INVENTION

The present invention overcomes the limitations of the prior art by providing a computer implemented online system for ready for production requests for companies to find and connect to qualified professionals and hiring them. The present invention meets companies demand a system that provides:
High speed of the production (direct messages to the candidates)
Easy to understand structure (profiles with past projects)
   Clear organization of the workflow
No outdated information
No garbage, no unnecessary people
A lot of different filters (People divided by section like their ability (to do offline rendering, or real-time rendering or do stylized, or do hard surface)

The present system provides all of these requirements and more overcoming the limitations of current systems.

The system offers two highly effective ways to hire or be hired. instant job posts and searchable professionals community database combines curated talent with an intuitive questionnaire—a powerful candidate screening tool ensuring an experienced, relevant, and more compatible job match.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

In the following description, certain terminology is used to describe certain features of one or more embodiments of the invention.

The term “platform” refers to various devices capable of playing a game, such as, a personal computer, an Internet browser, a dedicated gaming console, a tablet, and a smart phone.

The term “non-transient storage” refers to a database as is commonly known in the art.

Various embodiments provide a computer implemented online system for ready for production requests for companies to find and connect to qualified professionals and hiring them. In another embodiment, there is provided a method for using the system. The system and method will now be disclosed in detail.

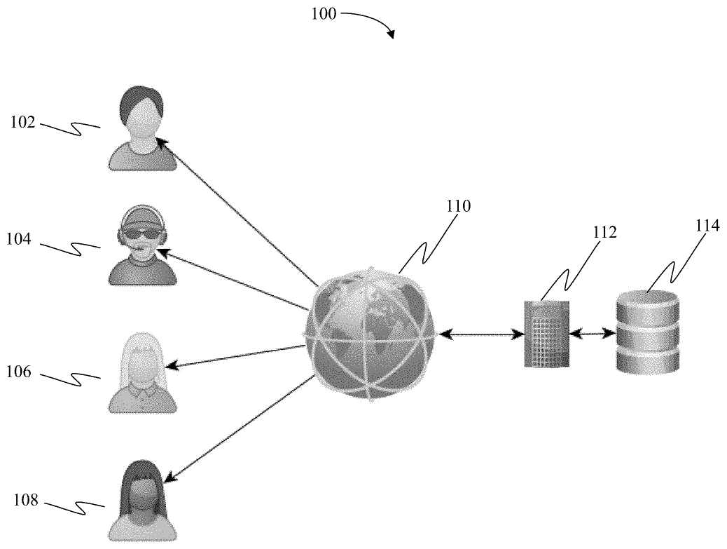

Referring now to FIG. 1, there is shown a overview diagram of a computer implemented online system 100 for ready for production requests for companies to find and connect to qualified professionals and hiring them, according to one embodiment of the present invention. Candidates 102 and 104 are invited to put their information onto the system 100 over the Internet 110. The system 100 comprises one or more than one processor 112 and one or more than on non-transient storage 114. The information provided by the candidate and stored in the non-transient storage 114, includes if they are currently looking for a position (full time or part time), a piece-work posting, or other types of availability. The system 100 expedites the recruitment process, replaces job postings, cold calls/messages with a more advanced, intuitive RFP system. The system 100 is easy to navigate and share profiles with colleagues. The system 100 comprises many different filters so companies and recruiters 106 and 108 can find qualified candidates quickly. The system 100 resolves inefficiencies and qualification gaps in job posting-based hiring. The system 100 prevents irrelevant responses from unqualified candidates. Candidate profiles clearly display if they are actively looking for work, which eliminates wasted time contacting uninterested candidates by the hiring company or recruiters 106 and 108. The system 100 reduces the amount of time spent searching for qualified candidates.

The system 100 also is beneficial for candidates. Unlike current job posting boards and websites, the system's 100 RFP process focuses on the candidate's needs and desires. The system 100 also provides an individual candidate promotion landing page for each candidate where the hiring company or recruiters 106 and 108 can look at past projects and other relevant material to the hiring process. Additionally, the system 100 provides website integration and promotional opportunities for both candidates and companies or recruiters 106 and 108. The system 100 reduces the amount of time spent searching job boards by qualified candidates as the companies or recruiters 106 and 108 reach out to them. The system 100 also comprises an easy-to-use profile constructor that enables opportunities to find candidates instead of the other way around. The system 100 puts candidates in direct contact with the right people up front without going through multiple levels of interviews and interactions that may not lead to a job opportunity.

The system 100 offers two highly effective ways for professionals 102 and 104 to hire or be hired. Instant job posts and searchable professional community database 114 combines curated talent with an intuitive questionnaire. a powerful candidate screening tool ensuring an experienced, relevant, and more compatible job match.

Professionals 102 and 104 join the service at no cost and create a profile within the system that features their previously completed professional work, much like an online portfolio. Recruiters 106 and 108 join the service at a cost, publish job posts that can be accessible by professionals 102 and 104 and search through professionals' portfolios to identify those candidates that meet the needs of a specific job opportunity that the recruiter 106 and 108 is looking to fill.

When the recruiter 106 and 108 has successfully registered an account on the system 100, they will be able to create a draft of a job post with the information about the job position, including the job title, geographic location of the job position, information about recruiter, including personal data of the authorized representative(s), and contact details, the terms of the job position and the requirements for professionals. The recruiter 106 and 108 also adds tags of the required skills, styles of content, and experience. Tags can be used by professionals to search related job posts. Job posts will be supplemented with default or customized questionnaires for professionals about the content and professional services.

The questionnaire must be completed by every professional 102 and 104 applying to the job post. The recruiter 106 and 108 may view the professionals 102 and 104 that applied to the job post and their profiles in the account on the system 100. The professional's 102 and 104 answers to the questionnaire and application to the job post will be regarded as an offer made by the professional 102 and 104 and not as an acceptance of the recruiter's 106 and 108 offer. No contractual relationship between the recruiter 106 and 108 and the professional 102 and 104 will exist except pursuant to a separate services agreement.

IF the recruiter 106 and 108 has identified a potential job candidate using the system, the recruiter 106 and 108 can send a questionnaire from the job post. Thre RFP's are transmitted directly and exclusively through the system 100. However, RFPs are not legally binding contracts but are rather a non-binding statement of intent, not unlike a letter of intent (LOI) used in the course of a real estate purchase or rental negotiation.

When the professional 102 and 104 receives an RFP from a recruiter 106 and 108, they may opt to respond to, accept, or turn down the RFP. If they respond, responses are sent to recruiters 106 and 108 are transmitted directly and exclusively through the system 100. The professional 102 and 104 and the recruiter 106 and 108 may use this functionality to “negotiate” the RFP until the professional 102 and 104 agrees to accept, or not accept, the opportunity. The ability to accept, or not accept, the RFP rests solely with the professional 102 and 104 to whom it was offered.

If a professional 102 and 104 accepts an RFP, they agree to provide professional services to the recruiter's 106 and 108 company by directly entering into a separate agreement (“services agreement”) with that company. These agreements are not a part of the present invention. However, as will be understood by those with skill in the art with reference to this disclosure, that type of service can be added.

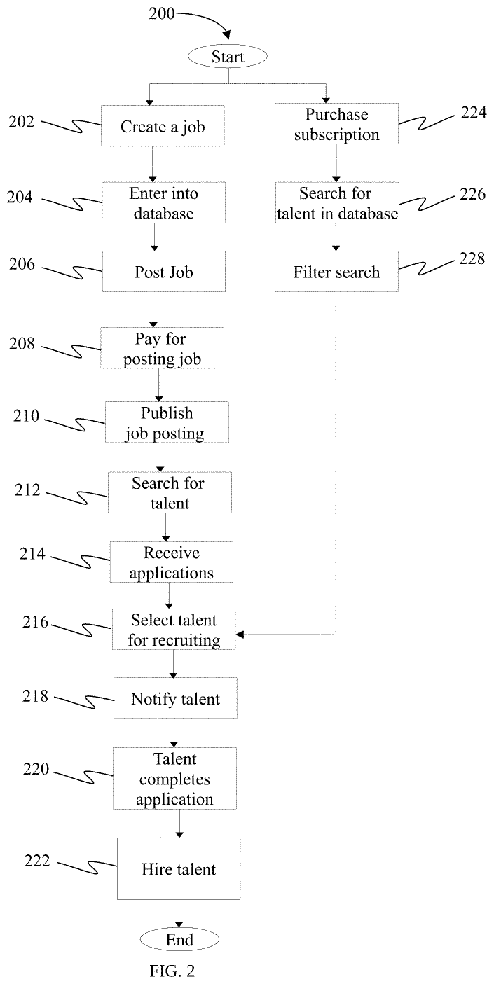

Referring now to FIG. 2, there is shown a flowchart diagram of a computer-implemented method 200 for generating ready for production requests to find and connect to qualified professionals 102 and 104 and hiring them.

First, a job posting 202 is created to search for candidates that the company is looking for to fill specific positions. Next, the job posting is entered into a non-transient storage or database 204. Then, the job is posted to the community board for all professionals 102 and 104 to see. Prior to the publication of the job post, payment 208 is entered. Next, the job is published 210. Then, the company can search 212 for professionals or talent to fill the published job posting 210. filters the available candidates by the needed skill set. Then, candidates respond to the RFP that are then received 214 by the company through the published job posting 210. Next, the companies send out questionnaires and RFP's to the selected candidates. Next, the talent, or professional, is notified of their selection 218. Then, the selected talent or professional completes any other application 220 required. Finally, the company selects a qualified candidate for hire 222.

Optionally, companies and recruiters 106 and 108 can subscribe to the system 224, thereby avoiding paying for each use of the system 100. Then, the companies or recruiters 106 and 108 can search 226 the non-transient storage database 114 for the talent or professionals that meet the hiring criteria. During the search process, companies can then search and filter from the invited candidates including candidates that are currently employed.

There is also provided a computer-implemented method for generating ready for production requests for companies to find and connect to qualified professionals and hiring them. The first thing that the company should do in the system is to create a job 202. At the beginning, the list of jobs is empty. To create the job 202, the company enters the name of position, text description, location, and specifies requirements in knowing particular skills, styles and tools using dropdown lists.

When the job is created 202, the recruiter 106 and 108 sees the filled card, that also contains information about candidates and the questionnaire. The questionnaire is a form that every created job includes from the beginning, which will be later be required for filling by professionals to apply for a job. The questionnaire has a default form and set of questions, but can be customized and re-designed for each job.

When the recruiter 106 and 108 complete customizing the job and the questionnaire, they click “Search for professionals” 226 and see the pricing information. The system 100 offers two ways of searching for talent; 1) through posting jobs on the board and receiving applications, or 2) through searching the non-transient storage database and connecting with professionals directly. The job post 206 can be purchased 208 separately, while the subscription 224 includes both options.

If the company or recruiter 106 and 108 decides to have just the job post, a payment interface 208 is displayed. The payment procedure will be skipped if the company has purchased subscription 224 before, because job posts 206 are included in the subscription plan offering. When the payment 208 is made, the job gets published 210 automatically, and the company or recruiter 106 and 108 get a link to a job board with it on the top of the list.

At this point, the published job 210 becomes visible for professionals on the job board. The page is open to public and can be seen by all users, no matter if they have accounts on the system.

If the company or recruiter 106 and 108 want to manually select professionals, they purchase the subscription 224 and get access to every professional's profile from the non-transient storage database 226. When company or recruiter 106 and 108 click the “Search database” button in the Job card, they get to this page, but it's also the main page of the service.

The company or recruiter 106 and 108 can narrow down the audience by using one or more than one filter 228. In one embodiment the following filters 228 are available: skills, experience, styles, tools, and location. When the company or recruiter 106 and 108 select filters, they go through the list, see profile previews, and decide whose profile to see or add to favorites to check later.

When the company or recruiter 106 and 108 open the profile, they see detailed information about the professional, including the name, location, current position, skills with experience level, styles, tools, and education (optional). Under the block with the info there're professional's work samples. If the company likes the profile, they might either add it to a favorites list for a closer look later, or hit the RFP button and see the list of their jobs, that they can start a conversation with the talent or professional.

When the company chooses the job 210 from the list and sends it to the professional 102 and 104, the latter receives the email notification about it.

Both links from the Job board or email notification lead the professional 102 and 104 to a questionnaire form associated with the job that the company offered. It might look differently, but the first screen always provides the candidate with more info about the opportunity. The professional 102 and 104 is asked to answer all questions from the form to complete the application 220. When the professional 102 and 104 completes the application 220, the company receives the email notification about it, and the professional's avatar appears in the “Candidates” field of the job card in RFP interface.

When the company or recruiter 106 and 108 click on the list of candidates on the card, a detailed view of all applications is displayed. No matter if the professional 102 and 104 applied to the job that was published on the website, or the company reached out to an professional 102 and 104 with this job directly, all responses will fall in this list. The page includes the list of received/pending applications, the professionals names, position and location, links to their profile and questionnaire responses.

The goal of the company or recruiter 106 and 108 at this stage is to check and compare all applications and select the best submission. The system 100 displays the professionals' 102 and 104 contact data to the company or recruiter 106 and 108 when professionals apply to the job. So when the company or recruiter 106 and 108 make a decision about the professional 102 and 104 they would like to invite for the interview, they copy their email and write the message there. The system 100 doesn't take any additional fees or limit the conversation between both sides, the goal of the system 100 is to match candidates with the company or recruiter 106 and 108.

What has been described is a new and improved system for a computer implemented online system for ready for production requests for companies to find and connect to qualified professionals and hiring them, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A computer-implemented method for generating ready for production requests for companies to find and connect to qualified professionals and hiring them, the computer-implemented method comprising:
a) creating a job posting;
b) entering the job posting information into a non-transient storage including tags;
c) posting the job;
d) paying for the job posting to be published;
e) automatically publishing the job posting;
f) automatically searching for talent to fill the job posting based on the tags entered;
g) automatically receiving talent applications in response to the job posting;
h) selecting talent from the received applications;
i) notifying the selected talent and sending the selected talent an application;
j) receiving the completed application from the selected talent; and
k) hiring the selected talent.

2. The method of claim 1, wherein the step of creating the job comprises a user entering the name of position, text description, location, and specifies requirements in knowing particular skills, styles and tools into the non-transient storage.

3. The method of claim 1, wherein when the job posting is created, information about each automatically selected candidate and questionnaires associated with each automatically selected candidate is sent to the user.

4. The method of claim 3, wherein the questionnaire is a default form and comprises set of questions that are customizable each job posting.

5. The method of claim 1, wherein a job postings are paid individually, by subscription or both individually and subscription; wherein posting jobs on the board and receiving applications is paid individually, and searching the non-transient storage and connecting with professionals directly is paid by subscription.

6. The method of claim 5, wherein each individual job posting displays a payment interface to a user.

7. The method of claim 6, wherein completion of payment automatically publishes the job posting, and a link to a job board with the job posting is automatically provided to the user.

8. The method of claim 7, wherein the published job posting is made visible for professionals on the job board and is open for public viewing.

9. The method of claim 5, wherein subscription users can manually select professionals and access every professional's profile from the non-transient storage using one or more than one pre-set filters.

10. The method of claim 9, wherein the pre-set filter comprise skills, experience, styles, tools, and location.

11. The method of claim 10, wherein a list of professionals displayed by the one or more than one pre-set filters, can be added to a favorites list for later review.

12. The method of claim 1, wherein the step of selecting the professional from the received applications displays a profile of detailed information about the professional, including the name, location, current position, skills with experience level, styles, tools, education, and work samples.

13. The method of claim 12, wherein the profile can be add it to a favorites list for later inspection or direct communication with the professional.

14. The method of claim 12, wherein selecting talent from the displayed list automatically sends an email to the selected professional.

15. The method of claim 14, wherein the email sent to the selected professional comprises links from the job board or email notification to a questionnaire form associated with the job posting.

16. The method of claim 15, wherein the professional is required to answer all questions from the questionnaire to complete an application.

17. The method of claim 16, wherein completion of the application automatically sends an email notification to the user and adds the professional to a job posting list related to the user.

18. The method of claim 1, wherein the listed candidates from the automatic or manual selection for the job posting displays a detailed view of all applications, including a list of received/pending applications, professionals names, positions, locations, links to profiles and questionnaire responses.

19. A computer-implemented system for ready for production requests for companies to find and connect to qualified professionals and hiring them, the system comprising:
a) at least one computer hardware processor; and
b) at least one non-transitory computer-readable storage medium storing professional information and processor-executable instructions that, when executed by the at least one computer hardware processor, cause the at least one computer hardware processor to perform:
1. creating a job posting;
2. entering the job posting into a non-transient storage including tags;
3. posting the job;
4. paying for the job posting to be published;
5. automatically publishing the job posting;
6. automatically searching for talent to fill the job posting based on the tags entered;
7. automatically receiving talent applications in response to the job posting;
8. selecting talent from the received applications;
9. notifying the selected talent and sending the selected talent an application;
10. receiving the completed application from the selected talent; and
11. hiring the selected talent.
